(19) United States
(12) Patent Application Publication
(10) Pub. No.: US 2008/0126114 A1
(43) Pub. Date: May 29, 2008

(54) SYSTEM AND METHOD FOR PROJECT MANAGEMENT OF LAND DEVELOPMENT

(75) Inventor: David Gregor McClure, Milton (CA)

Correspondence Address: REISING, ETHINGTON, BARNES, KISSELLE, P.C., P O BOX 4390, TROY, MI, 48099-4390, US

(73) Assignee: Edgeworth Properties Inc., Burlington (CA)

(21) Appl. No.: 11/680,240

(22) Filed: Feb. 28, 2007

Related U.S. Application Data
(60) Provisional application No. 60/867,270, filed on Nov. 27, 2006.

(51) Int. Cl. G06Q 10/00; G06Q 30/00

(52) U.S. Cl. 705/1

(57) ABSTRACT

A project management system for development of land is provided. An embodiment includes a project management engine interconnecting a plurality of workstations. Users at each workstation can select lots on a subdivision proposal. When the project management engine determines a sufficient number of lots are selected, provision of services for those lots commences in conjunction with a second project management engine.

### CROSS-REFERENCE TO RELATED APPLICATION

This application claims the benefit of U.S. Provisional Application Ser. No. 60/867,270, filed Nov. 27, 2006.

### FIELD OF THE INVENTION

The present invention relates real estate and more particularly relates to a system and method for project management of land development.

### BACKGROUND OF THE INVENTION

Converting a large piece of undeveloped real estate, such as farmland, into a number of habitable residences is an expensive, lengthy and complex process. Economic models which may appear to justify such development are subject to unforeseen fluctuations in the real-estate market, which can lead to potential financial disaster for the developer. This in turn can lead to a domino effect for more and more developers, leading to self-fulfilling prophecy of a deteriorating real-estate market. Ultimately, this can harm the consumer who may experience unacceptable delays in waiting for their home to be built.

At the opposite extreme, unexpected increases in a real estate market can benefit the developer, but can ultimately harm the consumer who may pay several times more for a home that would have cost considerably less had the land been developed more quickly.

It is known for real estate developers to finance the complete purchase and development of land and to ultimately sell developed lots, without or without homes to consumers. However, this model can suffer from the above-described problems.

It is also known for real estate developers to pre-sell completed homes to consumer prior to or during the development process. This involves the consumer paying some sort of deposit, with the balance payable on completion of the development process. However, the deposit cannot be financed as a traditional mortgage and so the consumer may face higher interest rates should it be necessary to finance the deposit. Also, as previously discussed, if the developer's economic model does not properly estimate the cost of trades and/or other services that are needed to build the home, the developer may face an unacceptable financial loss and/or cause delays in the completion of the home, if the home is ever completed at all.

Current attempts to reduce such uncertainty, to the benefit of the developer, investor and consumer requirement improvement.

### SUMMARY OF THE INVENTION

An aspect of the invention provides a system for project management of land development comprising a project management engine interconnecting a plurality of workstations. The project management engine is configured to receive data representing a subdivision plan. The project management engine is further configured to generate a representation of the subdivision plan to users operating the workstations, and to receive selections identifying selected lots on the subdivision plan. The project management engine is further configured to receive data representing a service contribution from each of the users for each of the selected lots. The project management engine is further configured to interface with a second project management engine to provide data to the second project management engine representing a priority in which the lots are to be serviced.

The project management engine and the second project management engine can be implemented on a single server.

The second project management engine can be configured to receive, in addition to the priority, a starting task, an ending task, a plurality of dependency tasks and a critical path for completion of servicing of the lots.

The project management engine can be further configured to receive and manage data representing funds received from the users in exchange for the lots.

The project management engine can be further configured to receive and manage data representing further funds received from the users representing the service contribution.

The project management engine can be further configured to automatically notify users that servicing of the selected lots has been completed.

The project management engine can be further configured to query each the user as to whether the user intend to transfer the lot respective to the user to another user. If the user indicates that the user intends to transfer the lot then the project management engine is further configured to perform a validation the transfer. The validation can comprise receiving data representing a balance of the service contribution as derived from the funds to be transferred from the another user to the user.

The project management engine can be configured to receive and manage data representing a balance of the service contribution.

The project management engine can be configured to generate data indicating that the user fully owns the lot once the balance of the service contribution is received.

Another aspect provides a method of project management of land development comprising:
receiving a subdivision proposal;
selling a right to purchasers, the right being a right purchase lots identified on the subdivision proposal;
receiving funds from each the purchaser representing the sale; and
receiving funds from each the purchaser representing a contribution to the provision of services for the subdivision.

The method can further comprise installing the services once a sufficient number of the contributions are received. The method can further comprise obtaining a balance of the contribution from each the purchaser. The method can further comprise receiving notification one of the purchaser intends to sell the purchaser's respective lot and deducting a balance of the contribution from a proceeds of sale of the purchaser's respective lot.

### BRIEF DESCRIPTION OF THE DRAWINGS

FIG. 1 shows a system for project management of land development.

FIG. 2 shows a flow chart depicting a project that can be managed using the system in FIG. 1.

FIG. 3 shows an exemplary proposed sub-division plan that can form part of the project outlined in FIG. 2.

FIG. 4 shows, the form of a flowchart depicting a method, an aspect of project management of land development implemented on the system of FIG. 1.

FIG. 5 shows the system of FIG. 1 as performing step 405 in the method of FIG. 4.

FIG. 6 shows the system of FIG. 1 as performing steps 415 and 425 in the method of FIG. 4.

FIG. 7 shows the system of FIG. 1 as performing steps 415 and 425 in the method of FIG. 4.

FIG. 8 shows, the form of a flowchart depicting a method, another aspect of project management of land development implemented on the system of FIG. 1.

FIG. 9 shows, the form of a flowchart depicting a method, another aspect of project management of land development implemented on the system of FIG. 1.

FIG. 10 shows the system of FIG. 1 as performing step 620 in the method of FIG. 9.

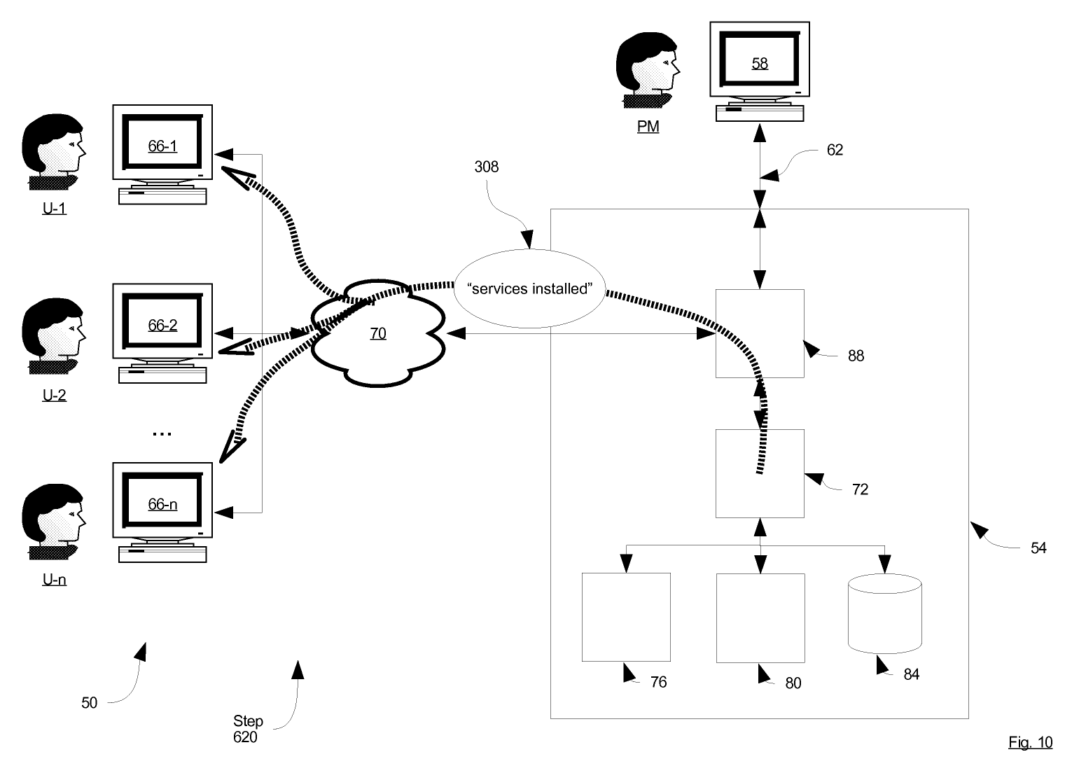

FIG. 11 shows, the form of a flowchart depicting a method, another aspect of project management of land development implemented on the system of FIG. 1.

FIG. 12 shows alternative system for project management of land development applicable to the method of FIG. 11.

FIG. 13 shows, the form of a flowchart depicting a method, another aspect of project management of land development implemented on the system of FIG. 1.

FIG. 14 shows the system of FIG. 1 as performing a portion of the method of FIG. 13.

### DETAILED DESCRIPTION OF THE EMBODIMENTS

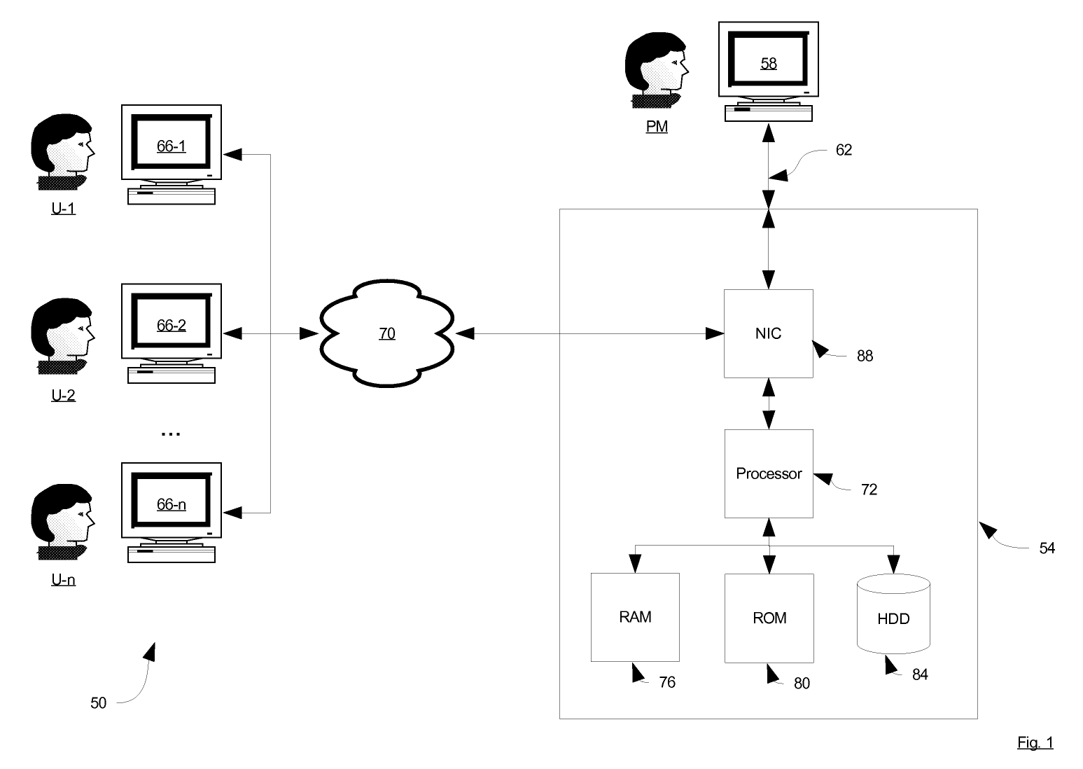

Referring now to FIG. 1, a system for project management of land development is indicated generally at 50. System 50 comprises a project management engine 54 that is connected to an administrator workstation 58 via a link 62. Project management engine 54 is also connected to a plurality of user workstations 66-1, 66-2 . . . 66-n via a network 70. Collectively, workstations 66-1, 66-2 . . . 66-n are referred to workstations 66 and generically, as workstation 66.

Project management engine 54 is based on server, a mainframe, or other type of computing environment. For example, project management engine 54 can be a Sun 480R server from Sun Microsystems, Inc. of Palo Alto Calif., which has four CPUs and, because a significant portion of project management processing is performed in random access memory, such a server should be configured with about eight to about sixteen gigabytes of random access memory. However, it is to be emphasized that this particular server is merely exemplary, a vast array of other types of computing environments for project management engine 54 are within the scope of the invention. Whichever computing environment is chosen, project management engine 54 is operable to process manage the development of line according to a project plan, as will be discussed in greater detail below.

As shown in FIG. 1, project management engine 54 comprises at least one processor 72 (also known as a central processing unit or CPU) that interconnects volatile storage, implemented as random access memory (“RAM”) 76, and non-volatile storage, implemented as read only memory (“ROM”) 80 and at least one hard disc drive (“HDD”) 84 or a redundant array of inexpensive disks (“RAID”). A network interface card (“NIC”) 88 connects processor 72 to link 62 and to network 70.

In a present embodiment, link 62 is an Intranet or other local area network or even a direct cable connection to workstation 58. Network 70 is the Internet or other wide area network that connects workstations 66 to server 54. However, those of skill in the art will now recognize that link 62 could be implemented as network 70, and vice versa.

Workstation 58 is typically a computing device such as a personal computer having a keyboard and mouse (or other input devices), a monitor (or other output device) and a desktop-module connecting the keyboard, mouse and monitor and housing one or more central processing units, volatile memory (i.e. random access memory), persistent memory (i.e. hard disk devices) and network interfaces to allow workstation 58 to communicate over link 62. However, it is to be understood that workstation 58 can be any type of computing device, such as a personal digital assistant, cell phone, laptop computer, email paging device etc. Workstation 58 is operated by a project manager PM, who interacts with engine 54 to act as an overall administrator for system 50.

Likewise, each workstation 66 is typically a computing device such as a personal computer having a keyboard and mouse (or other input devices), a monitor (or other output device) and a desktop-module connecting the keyboard, mouse and monitor and housing one or more central processing units, volatile memory (i.e. random access memory), persistent memory (i.e. hard disk devices) and network interfaces to allow the workstation 66 to communicate over network 70. However, it is to be understood that workstation 66 can be any type of computing device, such as a personal digital assistant, cell phone, laptop computer, email paging device etc. Each workstation 66 is operated by a user U respective to each workstation 66. Each user U can either be a sales representative acting on behalf of a consumer, or each user U can be the consumer themselves and/or combinations thereof. Each workstation 66 is used to receive consumer inputs from each respective user U.

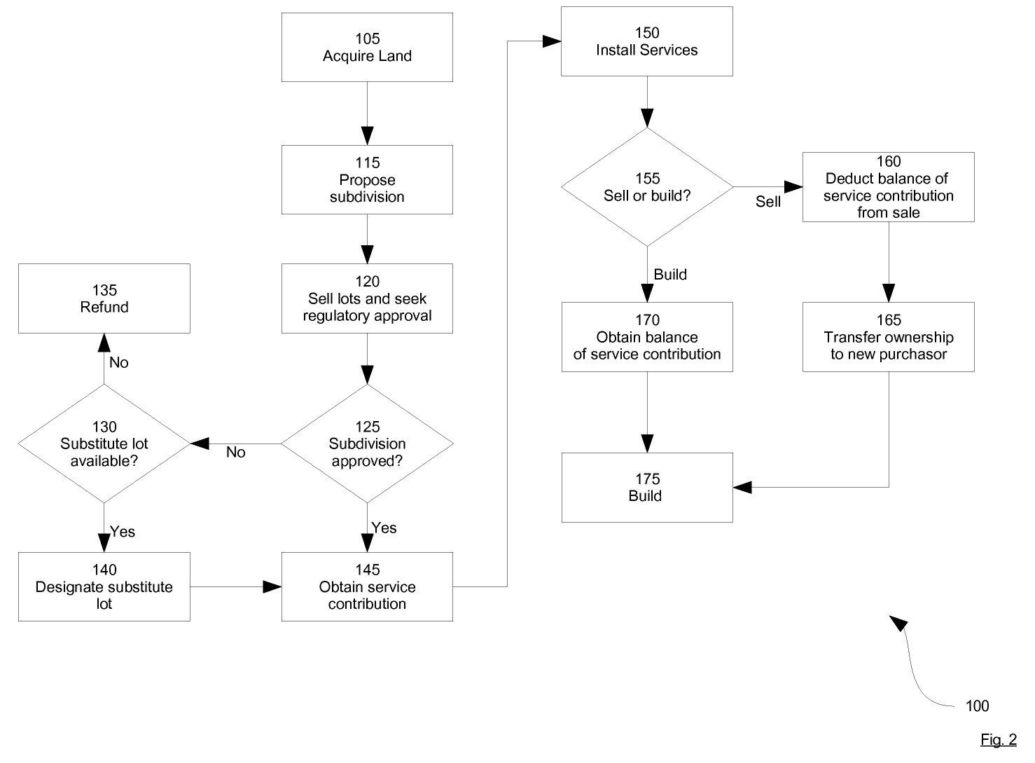

Referring now to FIG. 2, a flow chart defining an exemplary project to be managed according to system 50 of FIG. 1 is indicated generally at 100. It is also to be understood that the project steps indicated at 100 are, in and of themselves, new and inventive. At step 105, land is acquired. The land acquired at step 105 is undeveloped—for example, farm land, bush, government land or the like which is considered ready for development into a subdivision. The party or parties that acquire the undeveloped land are not particularly limited. For example, a real estate developer may acquire the entire block of land. Where legal, the real estate developer may, in turn, sell undivided interests in the land. In any event, the land acquired at step 105 has not been divided into individual subdivision lots.

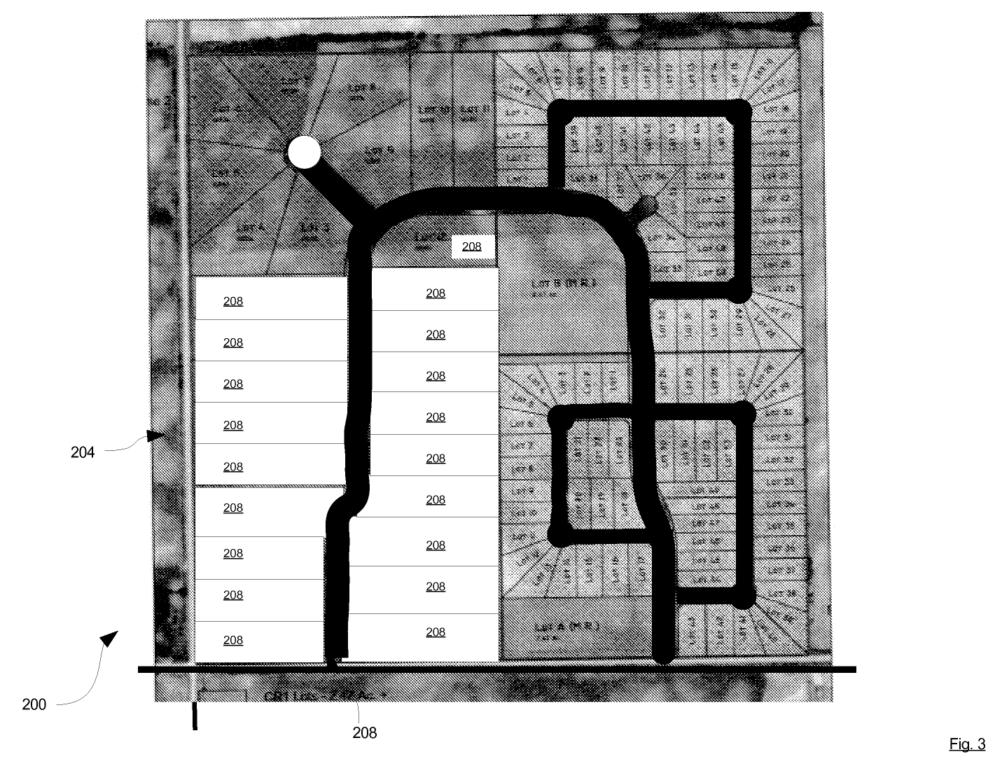

Next, at step 115, a subdivision is proposed. Referring now to FIG. 3, a proposed subdivision plan is indicated generally at 200. Plan 200 is characterized by a topological layer 204 that shows the land acquired at step 200. Layer 204 is shown with a plurality of proposed subdivision lots 208 is overlaid thereupon. Roads 208 are disposed between lots 208 to provide access thereto. It is important to note that plan 200, at this stage, is just that—a proposed subdivision plan. Plan 200 has been drawn by a skilled land surveyor, but no approvals have been given and no subdivision has been built. The actual land represented by topological layer 204 remains in the form indicated by topological layer 204. As part of step 115, proposed subdivision plan 200 is submitted to local government agencies, such as the local planning council of the municipal government, and/or environment impact review agencies, and/or the like for necessary regulatory approval.

Next, at step 120, lots are sold while regulatory approval for the subdivision is sought. In the present example, the lots sold at step 120 are the lots 208 shown in plan 200. Step 120 is performed concurrent with the approval process described above. The price for each lot is based on a market value of the lot in its undeveloped state, the market value being the date on which the sale occurs, with no services or building provided thereon. While it is presently preferred to sell all lots 208 at step 120, prior to advancing to step 125, it should be understood that only one lot 208 need be sold prior to advancing to step 125.

At step 125 a determination is made as to whether the proposed subdivision has been approved. Step 125 is performed after the regulatory approval process from step 120 is completed. If the all or part of the subdivision was not approved, then the method advances to step 130 and a determination is made as to whether a substitute lot is available. If no substitute lot is available, then the method advances to step 135 and a refund is provided. Step 135 would, of course, be applied to all lots if the entire subdivision was rejected. However, in many cases in fact, at step 130, it would be determined that substitute lots are available and thus the method would advance to step 140 and a substitute lot would be designated. If the substitute lot was of greater or lesser in value than the original lot then funds would be exchanged accordingly in order to address such variation.

At step 145, a service contribution is obtained. The service contribution would be based on a percentage of the actual costs that are needed in order to provide essential services to each lot 208, prorated for each lot 208. Such essential services include, but are not limited to, roads, sewers, water mains, electricity, gas, telephone, cable, fibre optic, regional parks and the like. A typical amount to obtain for a service contribution would be about fifty percent of the total prorated amount for each lot 208. For example, if the total cost of providing essential services to the subdivision was $1,000,000, and there were ten lots of equal size, then the prorated cost for providing services for each lot would be $100,000 per lot. Thus, fifty percent of this amount would be collected from each purchaser at step 120. Thus, ten times $50,000 for a total of $500,000 would be collected.

Advantageously, once subdivision approval has been achieved, deeds for each lot 208 can be provided to the purchasers at step 120, legal ownership over each lot 208 can vest with the purchase and at this point each purchaser can obtain a mortgage against their lot 208. Thus, the mortgaging option as of step 125 permits the purchaser to obtain financing to make the service contribution at step 145.

In the event that a purchaser from step 120 fails to provide the requisite service contribution at step 145, the purchaser will lose his/her interest in the lot and will receive a refund for the amount paid at step 120.

While not shown at step 145, if an insufficient service contribution is received then the method remains at step 145 until it is received, or, if a predefined period of time has elapsed without having received sufficient service contributions, then the method can end and all funds refunded to the purchasers from step 120. (Note that as used herein, the terms “sufficient” and “insufficient” are intended to convey whether or not an objectively defined threshold value has been reached.)

When and if sufficient service contributions are received, the method advances to step 150 at which point services are installed. At this point the project manager of system 100 can contact the contractors or other parties that are to install the requisite services for each lot 208 within the subdivision.

At step 155, each purchaser from step 120 then has an opportunity to decide whether to sell their lot 208 or to build on that lot. If they decide to sell, (which decision can be made also during the performance of step 150), then the method advances to step 150 at which point the administrator of project 100 will deduct the balance of the service contribution cost (i.e. the remainder of the amount not collected at step 145) from the sale. At step 165, the lot 208 will be transferred to the new purchaser.

It can be desired to establish at step 120 that the original owner of the land has the right to purchase the lot 108 back from the seller at step 160.

However, if at step 155 the purchaser from step 120 decides they intend to build on their lot 208, then at step 170 the balance of the service contribution cost (i.e. the remainder of the amount that was not collected at step 145) is collected from the purchaser from step 120.

The method then advances to step 175 at which point the owner of each lot 208 can proceed with building their home on their lot 208. However step 175 is reached, it should now be understood that the owner of each lot 208 now has full, unfettered ownership over their lot 208.

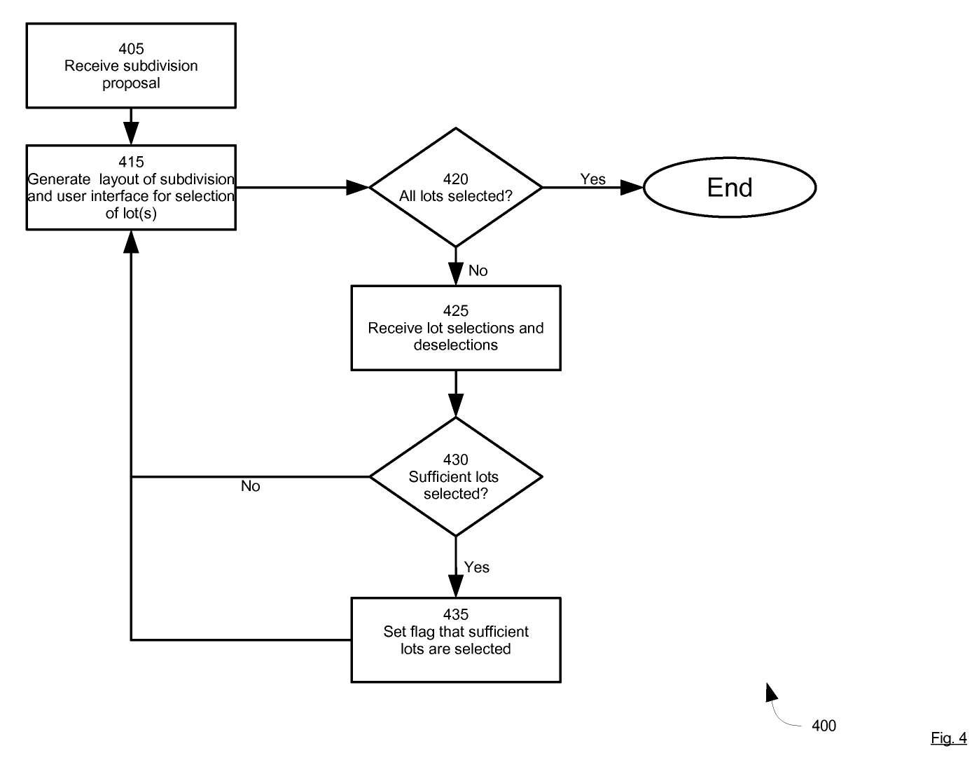

FIG. 4 shows a flowchart depicting a method 400 for an aspect of project management of land development. For purposes of explaining method 400, it will be assumed that method 400 is performed on system 50 in order to manage project 100. However, variations of method 400, system 50 and project 100 are all contemplated. In the present embodiment, method 400 is particularly directed to management of the selection of lots as previously discussed in relation to step 120 of project 100.

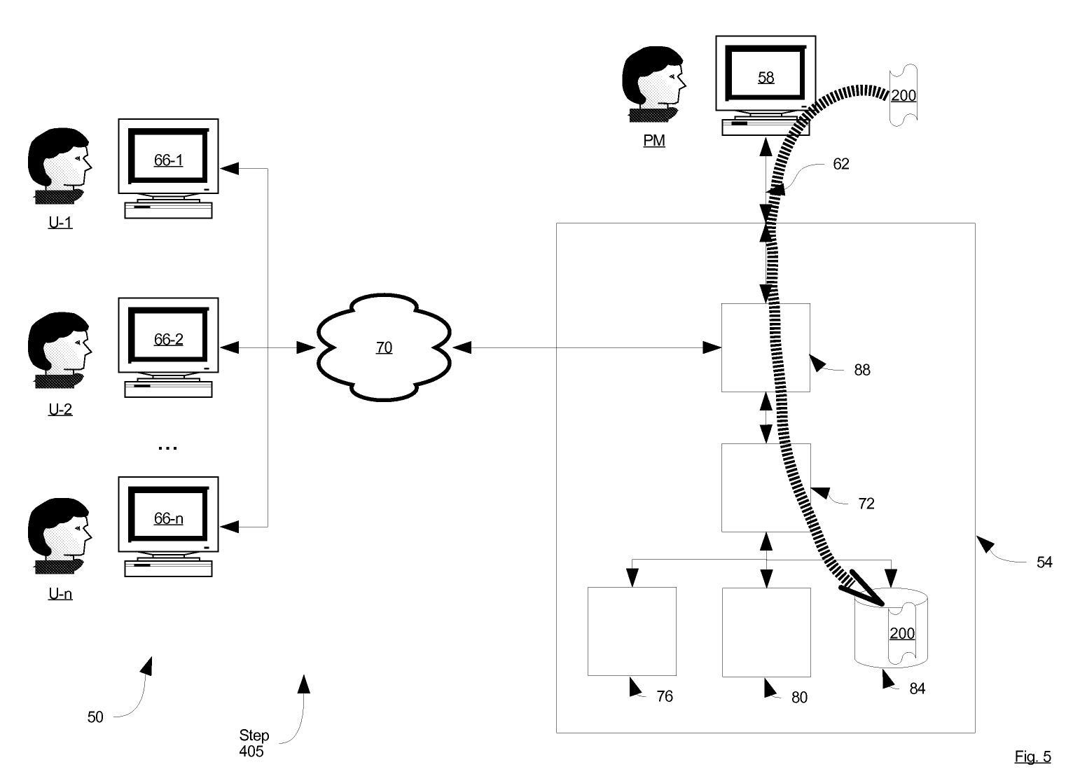

At step 405, a subdivision proposal is received. In the present example, proposed subdivision plan 200 is entered into workstation 58 by project manager PM and stored on hard disc 84 of engine 54. Step 405 is represented in FIG. 5. The means by which subdivision plan 200 is entered into workstation 58 is not particularly limited. Entry can be purely manual, or it can be based on an automation technique such as through the use of scanners, and/or via combinations of manual and automation techniques.

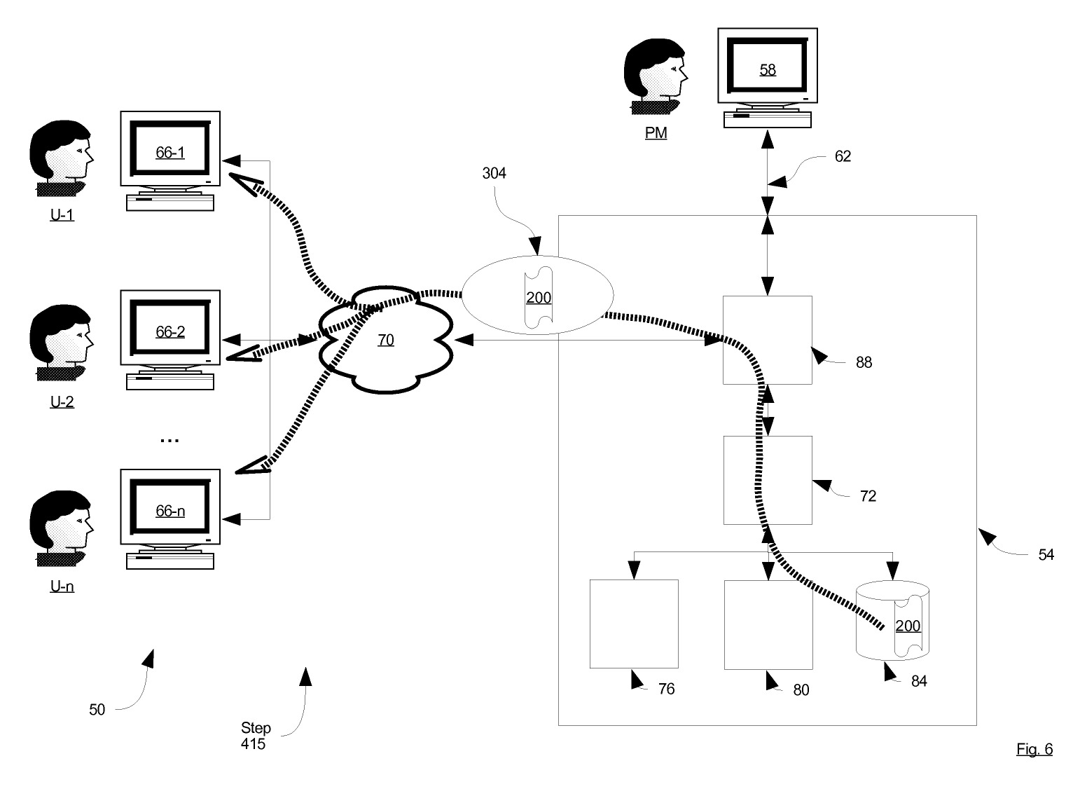

Next, at step 415, layouts representing proposed subdivision plan 200 are generated on each user workstation 66. Such generation of layouts is presented also within the context of a graphical user interface on each workstation 66. Step 415 is represented in FIG. 6, as a graphical user interface 304 (generated via executing on programming instructions on processor 72) containing a representation of plan 200 travels via network 70 to each user workstation 66.

One means by which graphical user interface 304 can be generated is via a web page, and so that graphical user interface 304 is opened via a web-browser executing on each workstation 66. Graphical user interface 304 permits, amongst other things, each user U to select available lots. Graphical user interface 304 also, dynamically, informs users U on other workstations 66 which lots have been previously selected and are no longer available. Graphical user interface 304 can also be configured to collect personal data for each purchaser, present legally binding electronic agreements, and optionally, receive payments for each lot 208 that is selected. Graphical user interface 304 can also allow each user U to “zoom in” and “zoom out” of various sections of plan 200 so that they can examine particular details about each lot 208 in greater detail.

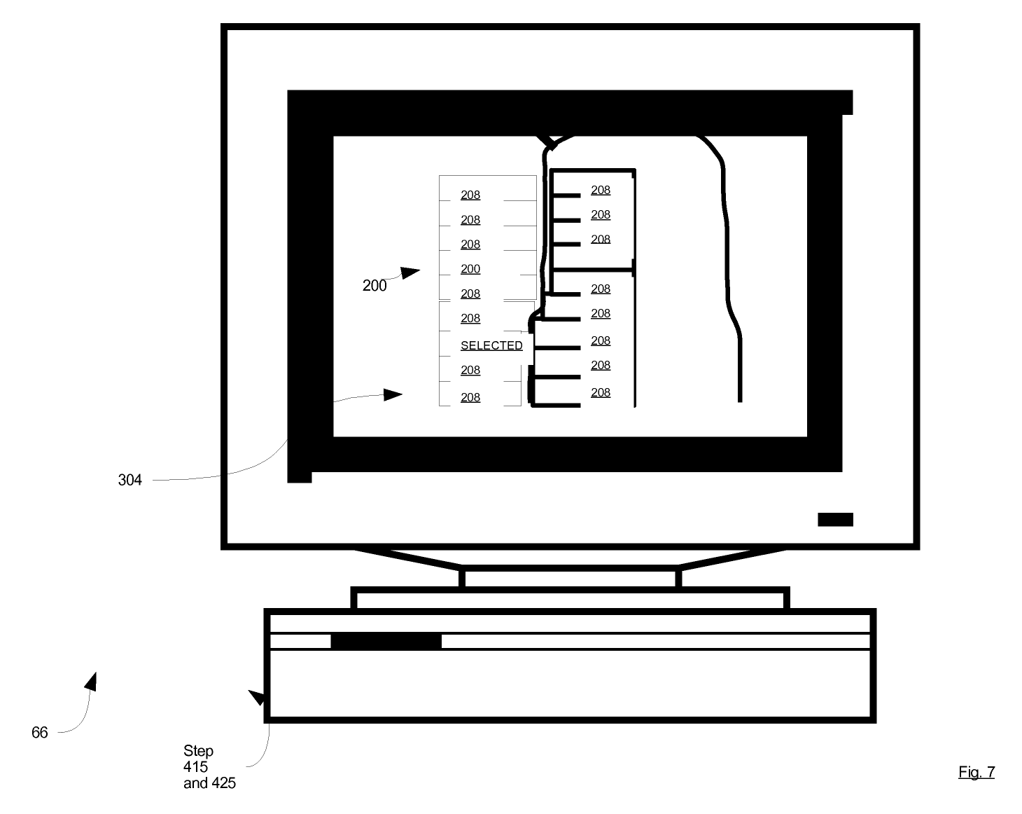

FIG. 7 shows an example of the appearance of graphical user interface 304, and the presentation of a portion of plan 200 shown thereon, with one of lots 208 as being marked as “selected”.

At step 420, a determination is made as to whether all lots have been selected. If “yes”, them method 400 ends. If “no”, then method 400 advances to step 425 whereby lot selections and deselections are received. (As used herein, the term “deselection” has the opposite meaning to “selection”.) Step 425 is performed much as previously described in relation to FIG. 7, whereby users U can browse through plan 200 and select desired lots 208.

At step 430, a determination is made as to whether a sufficient number of lots have been selected. Step 430 is effected for the benefit of another method 500, to be discussed later below, which manages step 145 of project 100. If at step 430, it is determined that a sufficient number of lots have been selected, then a flag is set within RAM 76 at step 435 so indicating that a sufficient number of lots have been selected. If a sufficient number of lots have not been selected, then the method returns to step 415. As part of setting the flag at step 435, project manager PM will be notified at workstation 58 so that project manager PM is informed that method 500 can commencing.

The threshold at which the flag at step 435 is triggered can be set according to any desired parameters. A presently preferred parameter corresponds to a certain threshold amount of essential services that are needed for those selected lots 208. In other words, a sufficient number of lots 208 should be selected so that the provision of services at step 150 of project 100 will benefit a minimum number of selected lots. In general, installing services at step 150 for only a single lot 208 is a wasteful use of project resources. The point at which installing services at step 150 will serve a sufficient plurality of lots 208, so as not to be wasteful of project resources, can be selected and defined as the threshold for which the flat at step 435 will be set. Another threshold that could be set for step 430 could be based on the point at which a sufficient number of lots 208 have been selected so as to suggest that a sufficient further number of lots 208 will be selected, in the future, so as not to be wasteful of project resources,

While not described expressly in method 400, it should also be understood that modifications and updates to subdivision plan 200 can be periodically entered into workstation 58, and where such modifications result in a material change to the layout or configuration of a given lot 208, then a user or purchaser of that lot 208 can be automatically notified and given the option of selecting a new lot, with the appropriate adjustment in the amount of funds remitted for such a new lot, if any. Or, that user can be provided with a refund. It is in this manner that steps 130, 140 and 145 of project 100 can be implemented.

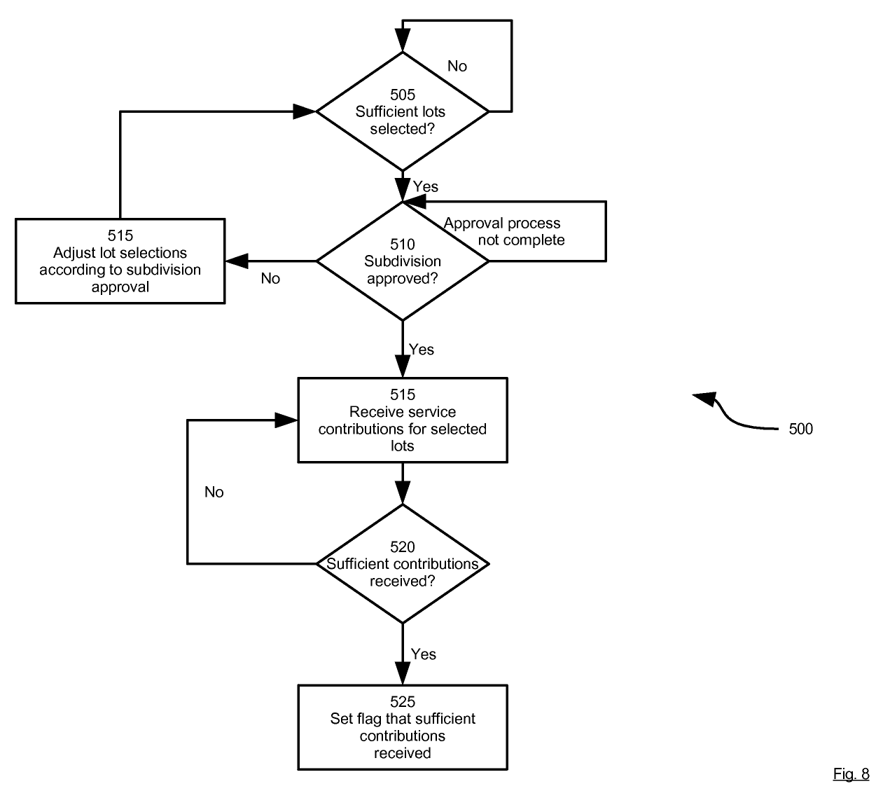

FIG. 8 shows a flowchart depicting a method 500 for an aspect of project management of land development. For purposes of explaining method 500, it will be assumed that method 500 is performed on system 50, in conjunction with method 400, in order to manage project 100.

Beginning at step 505, a determination is made as to whether a sufficient number of lots have been selected. This determination can be made based on one or more factors, such as whether it was determined at step 420 that all lots were selected, or that the flag at step 435 was set so as to indicate that a sufficient number of lots have been selected. This determination could also simply be a manual, override input from project manager PM indicating that a sufficient number of lots have been selected so that method 500 can proceed. If, it is determined at step 505 that a sufficient number of lots have not been selected then method 500 simply waits at step 505 until such point the determination at step 505 is “yes”.

Once a “yes” determination is made at step 505, method 500 advances to step 510. A step 510 a determination is made as to whether the subdivision has been approved. At step 510 it can be determined that the approval process simply is not complete and thus step 510 will continue to wait at step 510 until the approval process has been completed.

If at step 510 it is determined that the subdivision was not approved, then method 500 advances to step 515, at which point lot selections are adjusted according to what aspect, if any, of the subdivision was approved. Step 515 implements steps 130, 135 and 140 of project 100, and thus, if substitutions are not even possible, then at step 515 method 500 can terminate for any or all of those lots 208 that were selected but for which ultimate approval of those lots 208 was not obtained. If system 50 has been used to collect any funds from users or purchasers for whom a substitute lot cannot be found, then system 50 can likewise be employed to return such funds. If substitutions are possible, then the updated selection of a lot 208 is made based on the substitution and, if system 50 is so configured, adjustments to funds that were transferred in payment for the original lot 208 can be effected.

If at step 510 it is determined that approval for the subdivision (or at least a portion of the lots thereof) have been approved, then method 500 advances to step 515. At step 515, service contributions are received for each lot 208 that has been previously selected using method 400. That is to say, in certain embodiments of the invention confirmation that various service contributions for such lots 208 have been received, whereas in other embodiments, where system 50 is implemented with an electronic-commerce component, then engine 54 can be configured to actually administer electronic payment of funds associated with the service contributions.

At step 520, a determination is made as to whether sufficient service contributions have been made. If there is not a sufficient level of contributions have not been received then method 500 returns to step 515 until a sufficient level have been received. If at step 520, it is determined that a sufficient level of contributions have been received, then method 500 advances to step 525 where a flag within RAM 76 is set to indicate that a sufficient level have been received. The flag set at step 525 can be used within method 600, as discussed further below.

Those of skill in the art will now recognize that step 510 through step 525 implement a software based project management tool for step 145 from project 100, previously discussed.

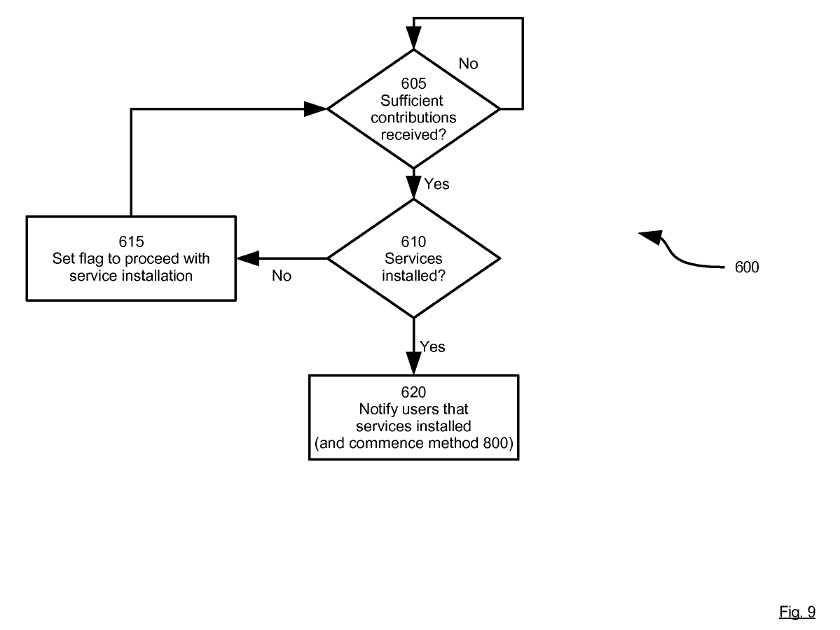

FIG. 9 shows a flowchart depicting a method 600 for an aspect of project management of land development. For purposes of explaining method 600, it will be assumed that method 600 is performed on system 50, in conjunction with method 400, and method 500, in order to manage project 100.

At step 605, a determination is made as to whether sufficient service contributions have been received. A “no” determination will be assumed at step 605 and thus method 600 will continue to wait at step 605 until a “yes” determination is made. A “yes” determination can be made based on whether the flag set at step 525 has been set, or, less presently preferred, it can be manually provided by project manager PM.

Next, at step 610 a determination is made as to whether services have been installed. The determination at step 610 can be a “yes” based on a flag that is set according to step 735 in method 700, discussed below. Presently less preferred however, the determination at step 610 can be set to “yes” or “no” based on manual input provided by project manager PM.

If the determination at step 610 is “no”, then method 600 advances to step 615 at which point a flag is set that indicates that services installation is to proceed. The flag set at step 615 is used in method 700, discussed below. The method then cycles between step 605, 610 and 615 until a “yes” determination is made at step 610.

Once a “yes” determination is made at step 610, method 600 advances to step 620, at which point a notification is sent to users U that services are installed. A representation of the performance of step 620, as a notification 308 is sent from processor 72 to each user workstation 66. Notification 308 can be based on an email, text, message, or can be part of graphical user interface 304 discussed previously. After completion of step 620, method 800, discussed below, commences.

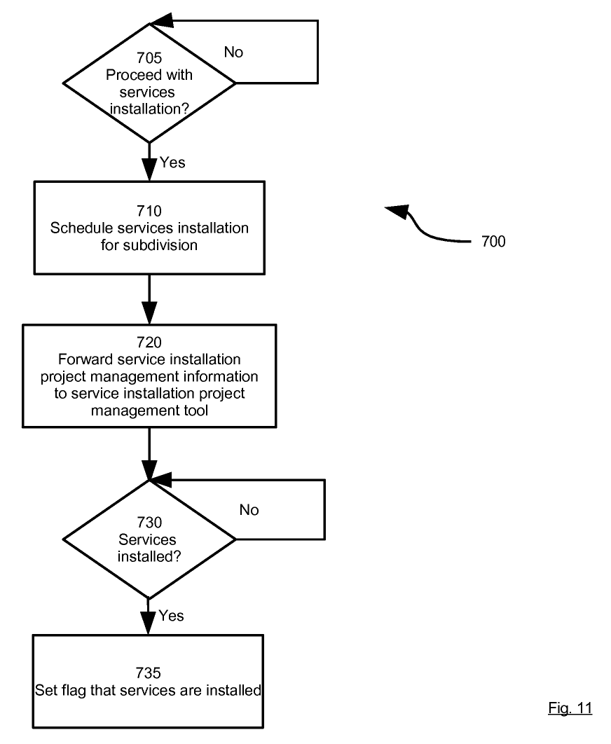

FIG. 11 shows a flowchart depicting a method 700 for an aspect of project management of land development. For purposes of explaining method 700, it will be assumed that method 700 is performed on system 50, in conjunction with method 400, method 500, and method 600 in order to manage project 100.

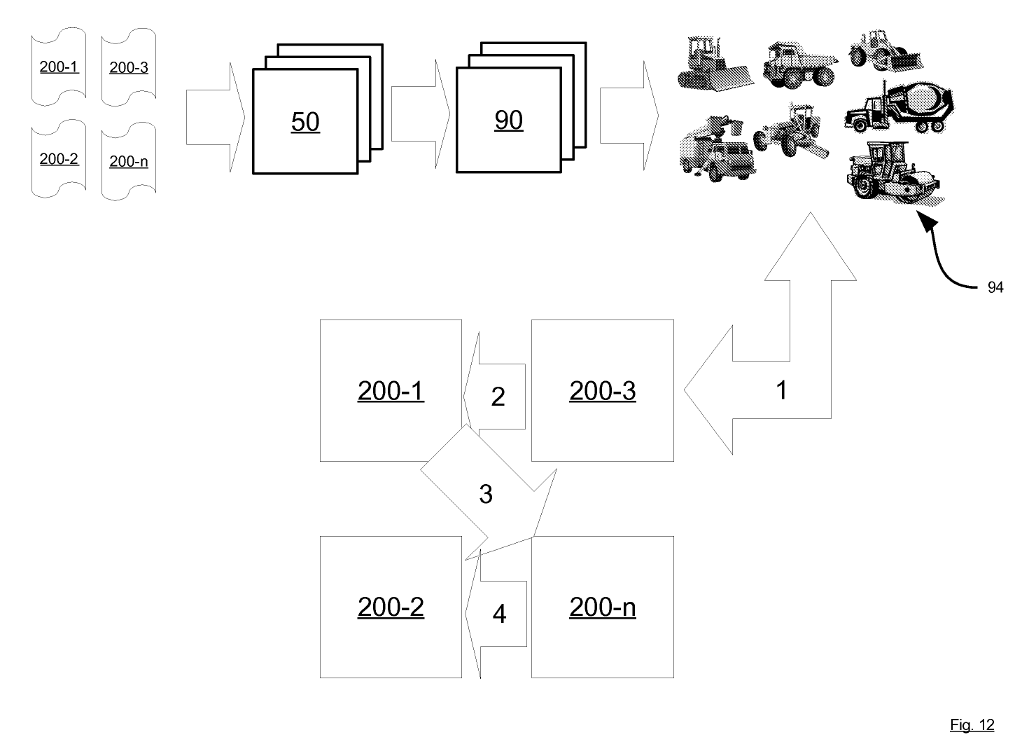

Before explaining method 700 further, an alternative embodiment illustrating the applicability of system 50 and the foregoing methods to various land development project management systems will be discussed. The alternative embodiment is illustrated in FIG. 12. In the alternative embodiment, system 50 is used to manage projects for a plurality of different subdivision plans 200-1, 200-2 . . . 200-n, and system 50 is also connected to a traditional project management system 90. Traditional project management system 90 can be based on, for example, Microsoft Project from Microsoft Corporation of Redmond Wash. Using system 90, a starting point, ending point, tasks, a critical path, and plurality of dependencies for each task can be entered in the usual manner. System 90 can then be used to direct the use of heavy machinery 90 for the purposes of installing the services for each subdivision plan 200-1, 200-2 . . . 200-n. As projects for each subdivision plan 200-1, 200-2 . . . 200-n are managed by system 50, system 50 can then in turn instruct system 90 as to the order in which services for each subdivision plan 200-1, 200-2 . . . 200-n should be installed, and accordingly, system 90 can likewise allocate machinery 90 in the most effective manner. In the example of FIG. 12, system 50, in conjunction with system 90 have allocated machinery 90 to the installation of services in the order of plan 200-3, 200-1, 200-n and 200-2. FIG. 12 illustrates one the technical effects of the present invention, as the processing unit of system 90 achieves an allocation of machinery 94 that is more efficient than without the input from system 50. Machinery 94 is allocated to the subdivision plan in an order that matches the rate at which lots in those subdivisions are being acquired. Put in other words, system 50 and system 90 effect a “first-in-first-out” whereby lots are serviced substantially in the order in which they are selected and the respective subdivisions plans are approved. Without system 50, system 90 could result in a “last-in-first-out” servicing of subdivision lots.

(Those skilled in the art should now recognize also that the example in FIG. 12 could be applied to portions or areas of a single subdivision 200, rather than to multiple subdivisions, to install services in a single subdivision on a first-in-first-out basis.)

Thus, returning now to method 700, method 700 provides the output to system 90 as shown in FIG. 12. Multiple instances of method 700 (and the foregoing other methods) can also be operating in order to achieve the project scheduling described in relation to FIG. 12. At step 705 a determination is made as to whether to proceed with services installation. The determination at step 705 can be a “yes” based on a flag that is set at step 615 in method 600. If the determination at step 705 is “no” then method 700 waits at step 700 until a “yes” determination is made. Next, at step 710, services are scheduled for installation for a subdivision. Next, at step 720, the results of step 710 are forwarded to a project management engine. Step 720 thus provides input to system 90, which in turn uses other traditional project management engines, as previously described, to allocate machinery 94 to the installation of services for various subdivisions.

Next at step 730, a determination is made if the services are installed. If the determination is “no”, then the method waits at step 730 until the determination is “yes”. A “yes” determination can be made when project management system 90 is updated to indicate that a critical path for the installation of services for a particular subdivision is complete, whereby management system 90 is configured to provide automatic input back to system 50 (and by extension, step 730) advising of same. Next, at step 735, a flag is set indicating that the services have been installed for a subdivision 200, which is usable at step 610 of method 600.

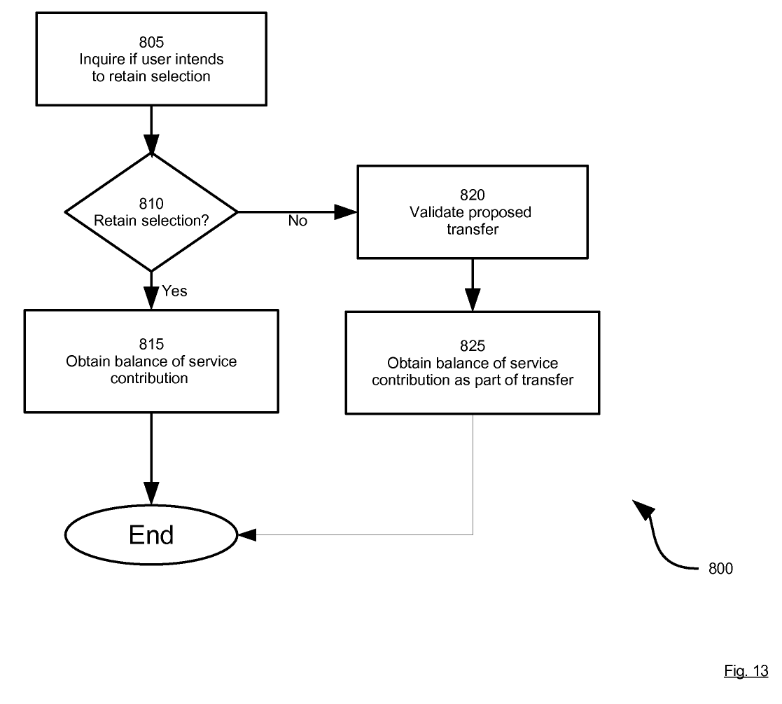

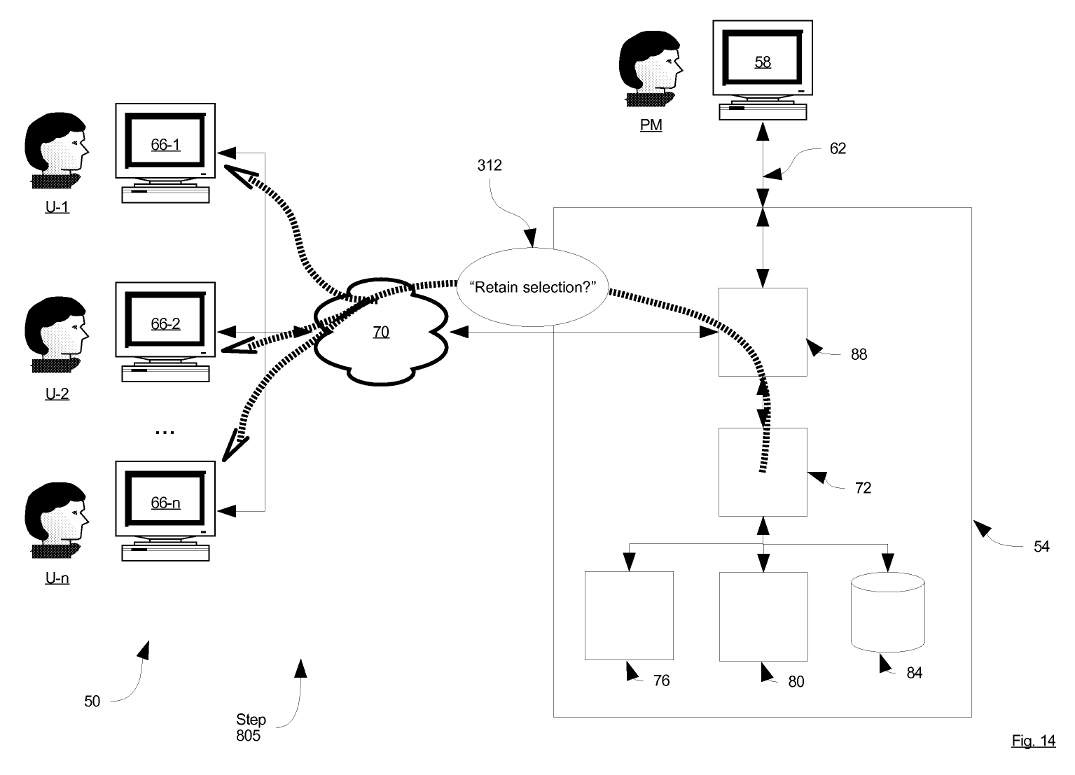

FIG. 13 shows a flowchart depicting a method 800 for an aspect of project management of land development. For purposes of explaining method 800, it will be assumed that method 800 is performed on system 50, in conjunction with method 400, method 500, method 600 and method 700 in order to manage project 100. At step 805, an inquiry is made as to whether a user intends to retain it selection of a given lot. Performance of step 805 is represented in FIG. 14, as an inquiry 312 (tailored specifically to each user U) is made asking if the user U intends to retain his/her selected lot 208, now that this particular lot has been serviced. Step 805 can, in fact, be performed substantially at the same time and in the same manner as 620. Typically, each user U will only be given a predefined time period in which to apply, otherwise it will be assumed that the user U intends to retain the particular selection. Next, at step 810, a response is assessed for each user U. If it is determined at step 810 that a user U has elected “no” it will not retain the selected lot 208, then method 800 advances to step 820 at which point, whatever the form of transfer of lot 208 from user U is validated. User U may have arranged, privately to transfer (typically for monetary value) his/her lot 208 to another user U. System 50 can, optionally, be configured to validate whether the transaction is bona fide, and, if not system 50 can be configured to refuse the transfer and/or insist that the transfer be made to the original acquirer of land 204. Assuming the transfer is validated, method 800 advances to step 825 at which point the balance of the service contribution (the initial portion of which was received at step 515) is obtained, either from the transferor user U or the transferee user U. In a presently preferred embodiment, system 50 brokers, via electronic commerce methods, any actual sale and deducts the balance of the service contribution from the funds being remitted by the transferee user U to the transferor user U.

While only specific combinations of the various features and components of the present invention have been discussed herein, it will be apparent to those of skill in the art that desired subsets of the disclosed features and components and/or alternative combinations of these features and components can be utilized, as desired.

The above-described embodiments of the invention are intended to be examples of the present invention and alterations and modifications may be effected thereto, by those of skill in the art, without departing from the scope of the invention which is defined solely by the claims appended hereto.

1. A system for project management of land development comprising:
a project management engine interconnecting a plurality of workstations; said project management engine configured to receive data representing a subdivision plan; said project management engine configured to generate a representation of said subdivision plan to users operating said workstations, and to receive selections identifying selected lots on said subdivision plan; said engine further configured to receive data representing a service contribution from each of said users for each of said selected lots; said engine further configured to interface with a second project management engine to provide data to said second project management engine representing a priority in which said lots are to be serviced.

2. The system of claim 1 wherein said project management engine and said second project management engine are implemented on a single server.

3. The system of claim 1 wherein said second project management engine is configured to receive, in addition to said priority, a starting task, an ending task, a plurality of dependency tasks and a critical path for completion of servicing of said lots.

4. The system of claim 1 wherein said project management engine is further configured to receive and manage data representing funds received from said users in exchange for said lots.

5. The system of claim 1 wherein said project management engine is further configured to receive and manage data representing further funds received from said users representing said service contribution.

6. The system of claim 1 wherein said project management engine is further configured to automatically notify users that servicing of said selected lots has been completed.

7. The system of claim 6 wherein said project management engine is further configured to query each said user as to whether said user intend to transfer said lot respective to said user to another user.

8. The system of claim 7 wherein if said user indicates that said user intends to transfer said lot then said project management engine is further configured to perform a validation said transfer.

9. The system of claim 8 wherein said validation comprises receiving data representing a balance of said service contribution as derived from the funds to be transferred from said another user to said user.

10. The system of claim 6 wherein said project management engine is configured to receive and manage data representing a balance of said service contribution.

11. The system of claim 10 wherein said project management engine is configured to generate data indicating that said user fully owns said lot once said balance of said service contribution is received.

12. A method of project management of land development comprising:
receiving a subdivision proposal;
selling a right to purchasers, said right being a right purchase lots identified on said subdivision proposal;
receiving funds from each said purchaser representing said sale; and
receiving funds from each said purchaser representing a contribution to the provision of services for said subdivision.

13. The method of claim 12 further comprising installing said services once a sufficient number of said contributions are received.

14. The method of claim 13 further comprising obtaining a balance of said contribution from each said purchaser.

15. The method of claim 13 further comprising receiving notification one of said purchaser intends to sell said purchaser's respective lot and deducting a balance of said contribution from a proceeds of sale of said purchaser's respective lot.
